(19) United States
(12) Patent Application Publication
(10) Pub. No.: US 2015/0012820 A1
(43) Pub. Date: Jan. 8, 2015

(54) SYSTEM AND METHOD OF PUBLISHING COMPOSITIONS

(71) Applicant: Mark Thomas App, Beavercreek, OH (US)

(72) Inventor: Mark Thomas App, Beavercreek, OH (US)

(21) Appl. No.: 14/322,542

(22) Filed: Jul. 2, 2014

Related U.S. Application Data
(60) Provisional application No. 61/842,076, filed on Jul. 2, 2013.

(51) Int. Cl. G06F 17/24; G06F 3/0484

(52) U.S. Cl. CPC G06F 17/24; G06F 3/04842
USPC 715/256

(57) ABSTRACT

A system and method of publishing compositions is provided. The system and method includes publishing blocks, such as chapters or scenes, of the composition separately. Therefore, the original author or third party users may create new blocks based on the original blocks. The new blocks may include previous chapters, variations of the original block, or new chapters that may continue the story line. Therefore, a single block may start the beginning of a various amount of completed compositions.

### CROSS-REFERENCE TO RELATED APPLICATION

This application claims the benefit of priority of U.S. provisional application No. 61/842,076, filed Jul. 2, 2013, the contents of which are herein incorporated by reference.

### BACKGROUND OF THE INVENTION

The present invention relates to publishing compositions of work and, more particularly, to publishing segments and adding additional segments to compositions of work.

Books, scripts, writings and the like are currently released and presented as completed works, and often in a serial manner. For example, books are released and presented as a grouping of chapters. Further, the book may have a prequel or sequel that begins either before or after the story of the book. This causes a problem for the writers and the readers of the composition. For the author, the present method constrains them by making it more difficult to branch new stories from a block within a composition. Also authors currently cannot publish a chapter or two to test the chapter with reader's for sales purposes and comments prior to completing the next chapter or more of the book. This prevents the author from updating existing published chapters, or dynamically taking the story in a different direction. For the readers, the present method only allows them to purchase an entire work or set series without knowing if they have an interest in reading a longer portion of the work.

As can be seen, there is a need for a system and method of incrementally publishing compositions of work by one or more authors.

### SUMMARY OF THE INVENTION

In one aspect of the present invention, a system for publishing a writing, comprises: a database; a computer having a user interface, wherein the computer has access to the database; and a program product comprising machine-readable program code for causing, when executed, the computer to perform the following process steps: prompting a first user to upload a plurality of blocks of the writing to the database comprising at least one first block, wherein a block comprises a segment of the writing; producing the at least one first block to be viewable by the first user and at least one of a plurality of third party users; prompting at least one of the first user and the third party users to upload at least one second block to the database, wherein the second block comprises a segment of the writing that is a continuation of the first block; and producing the at least one second block to be viewable by the first user and at least one of the plurality of third party users.

In another aspect of the present invention, a method of publishing a writing comprises: producing at least a first block by a first user, wherein a block comprises a segment of the writing; publishing at least the first block to at least one of a plurality of third party users and the first party; producing at least a second block by at least one of the first user and the plurality of third party users, wherein the second block is a continuation of a story of the first block; and publishing the second block to at least one of a plurality of third party users and the first party.

These and other features, aspects and advantages of the present invention will become better understood with reference to the following drawings, description and claims.

### BRIEF DESCRIPTION OF THE DRAWINGS

The FIGURE is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method of publishing compositions. The system and method includes publishing blocks, such as chapters or scenes, of the composition separately. The original author or third party users may create new blocks based on the original blocks. The new blocks may include previous chapters, variations of the original block, or new chapters that may continue the story line. Therefore, a single block may start the beginning of a various amount of mixed and matched compositions.

The present invention includes a system and method for incrementally publishing a user's composition, such as books, on a network. The present invention allows for incremental release and electronic presentation of work, collection of feedback for composite blocks of their work, and allows authors to dynamically update and branch from their work at multiple points. Authors can control whether other authors are allowed to branch from their composite blocks, which may include collecting a one-time fee or some form of future payment based on future sales of branched works. This may provide the author a way to capitalize on any partial completed block of work and generate a new source of income from other authors. Also the readers have the option to purchase only a portion of works, which may increase the quality of works by incentivizing the writer to create blocks that encourage readers to view and/or purchase follow up blocks.

A user of the present invention may include a creative user, a purchaser, or a combination thereof. The creative user may publish blocks of work one at a time or in bulk. The block of work may include a chapter of a book, a scene of a play and the like. In certain embodiments, the creative user or author uses the graphic user interfaces to load, write, and/or modify blocks or a work. Then the creative user may use the graphic user interface to decide how many of the blocks to present or share for other individuals, user groups, or the public.

When the author shares or presents other blocks (e.g. chapters/scenes) for view or purchase, the author may decide how many of the blocks are included, what price (or at no cost) each individual block may cost to other users, and what individuals, groups, or public can view. Once the author selects the above options, the blocks may be presented in a library or store-like graphic user interface, which enables other users or the public to view and/or purchase the published blocks. The creative user may then add to and branch (for free, one-time cost, future payment based on future sales, etc) from the already shared/released block incrementally. The branching does not have to be linear and can occur from any of the previously shared/published blocks forming a branch structure

The present invention may include a program product software that is loaded on a computer or server. The software is machine-readable program code for causing, when executed, the computer to perform steps. The computer of the present invention may be any processing device that may access a database. The computer includes a user interface, or presentation screen, to display the information within the database to the users. The computer may access the database by using the internet, extranet, intranet, host server, internet cloud and the like.

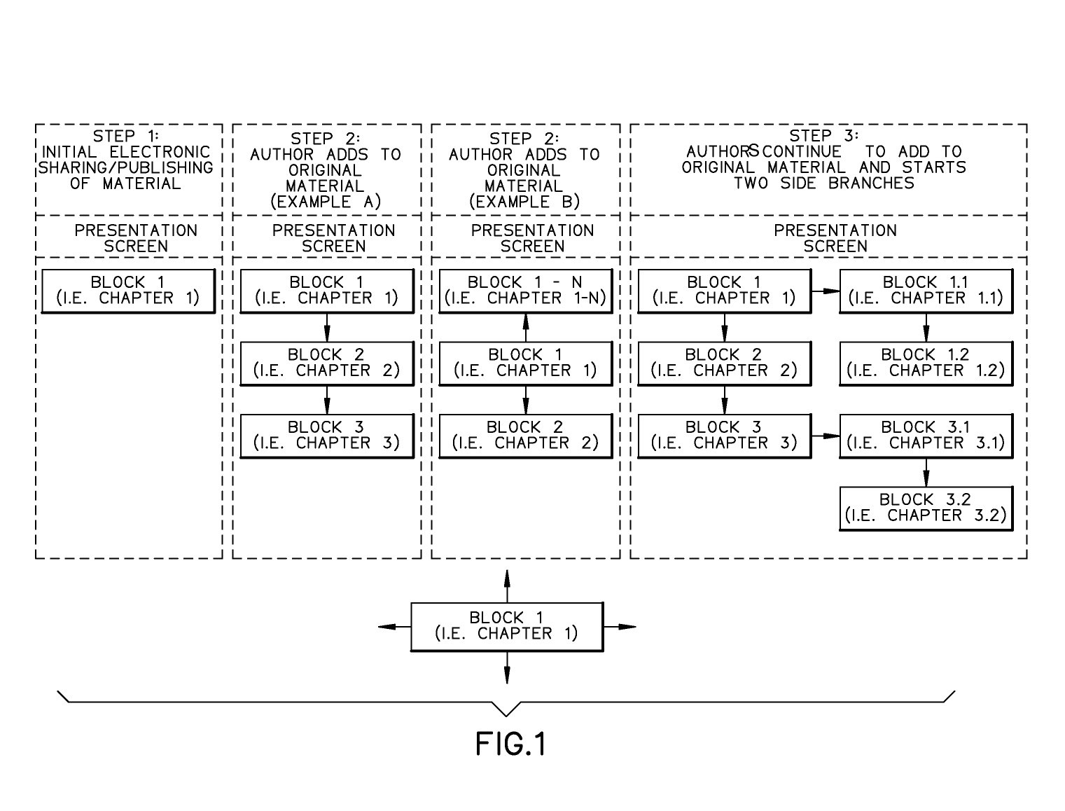

Referring to FIG. 1, the present invention may include a network of authors and purchasers having access to the database. The authors may include at least a first user and a plurality of third party users. The purchasers may include the third party users. The first user has the option to upload a plurality of blocks. A block may include a segment of a writing, such as a chapter of a book or a scene of a drama. The first user may upload at least one first block to the database, such as Block 1. In certain embodiments, the first user may upload a plurality of blocks, segmented out as individual chapters of books. This is illustrated as Block 1, Block 2, and Block 3.

The blocks that are uploaded by the first user to the database may be produced to at least one of a plurality of third parties. In certain embodiments, the blocks may be edited by the first user and/or by the third parties. The first user may control who views and/or edits the blocks. For example, the first user may set an amount of money for each individual block. Therefore, third parties may purchase each individual block at the set price. In certain embodiments, the first user may setup a group of third parties. The group of third parties may include individuals that have access to the blocks produced by the first user. This allows the first user to have control over who views the blocks that they have created.

Once the blocks have been uploaded to the database and are viewable to the first user and the plurality of third party users, additional blocks may be added. For example, at least one of the first user and the third party users may upload at least one second block. The second block may include a segment of writing that is a continuation of the first block. Therefore, the first user may create a first chapter, and a second user may create the second chapter. Like the first block, the second block is published for users to view, purchase, or add additional blocks including additional chapters. When subsequent blocks are purchased a portion of that purchase amount may be divided in part to the first user or users who produced earlier block(s) that established the foundation for a later block.

A block may be added before the first block (Block 1). This block may be considered Block 1−n, where N can be any number of blocks added before the first block. Using such embodiments, an author or third party user may attach a number of blocks before an existing first block to create a prequel or a back story to the first chapter.

In certain embodiments, a plurality of second blocks may be produced by a plurality of different users, such as such Block 1.1, Block 1.2, Block 3.1, and Block 3.2. Each second block produced may produce a new branch of the story line. Users may then add third blocks to the second block of choice and so on. Therefore, the present invention allows users to add their own chapters that continue from any chapter of choice of an already published writing. The user may finish the story, or potentially other users may start where others left off, contribute to and/or finish the story.

By following the above-listed steps/methods, the blocks of work can be incrementally presented and viewed and then potentially purchased by users as a form of publishing a creative work, for example a book/novel. This process and method can be used to incrementally share or present any composite section of books like chapters/scenes or anything in writing, to include but not limited to books, stories, poems, instruction manuals, scripts and the like.

In certain embodiments, one or more blocks could be sold or leased to other users. Blocks could be purchased in groups by money, tokens, or some other credits. In addition, the presentation and purchase of block(s) could include not only a physical interface or presentation of the text on the network but also interfacing and presenting by audio of the creative work. The process and methods are on a network and may be offered to any limited groups like a school or members of a business, or to the public on any computer, such as a home/work/auto computing devices, or mobile devices.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer, For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for publishing a writing, comprising:
a database;
a computer having a user interface, wherein the computer has access to the database; and
a program product comprising machine-readable program code for causing, when executed, the computer to perform the following process steps:
prompting a first user to upload a plurality of blocks of the writing to the database comprising at least one first block, wherein a block comprises a segment of the writing;
producing the at least one first block to be viewable by the first user and at least one of a plurality of third party users;
prompting at least one of the first user and the third party users to upload at least one second block to the database, wherein the second block comprises a segment of the writing that is a continuation of the first block; and
producing the at least one second block to be viewable by the first user and at least one of the plurality of third party users.

2. The system of claim 1, wherein the program product further causes the machine to perform the step of:
prompting the first user to set an amount of money for purchasing the at least one first block of writing;
prompting at least one of the third party users to purchase the at least one first block of writing; and
producing the at least one first block of writing to the third party user that purchased the at least one first block of writing.

3. The system of claim 1, wherein the program product further causes the machine to perform the step of:
prompting the first user to select a group within the plurality of third party users; and
producing the at least one first block of the writing to the selected group of third party users.

4. The system of claim 1, wherein the program product further causes the machine to perform the step of:
prompting at least one of the first user and the third party users to upload a plurality of second blocks; and
producing the plurality of second blocks creating a plurality of branches, wherein the at least one of the first user and the third party users are able to add additional blocks to each branch.

5. The system of claim 1, wherein the program product further causes the machine to perform the step of:
prompting at least one of the first user and the third party users to upload at least one third block, wherein the third block comprises a segment of the writing that is a continuation of the first block or the second block.

6. The system of claim 1, wherein the segment of writing is a chapter of a book or a scene of a drama.

7. The system of claim 1, wherein the program product further causes the machine to perform the step of:
prompting at least one of the first user and the third party users to edit the produced blocks.

8. A method of publishing a writing comprising:
(a) producing at least a first block by a first user, wherein a block comprises a segment of the writing;
(b) publishing at least the first block to at least one of a plurality of third party users and the first party;
(c) producing at least a second block by at least one of the first user and the plurality of third party users, wherein the second block is a continuation of a story of the first block; and
(d) publishing the second block to at least one of a plurality of third party users and the first party.

9. The method of claim 8, further comprising the step of:
(e) setting an amount of money for purchasing the at least one first block of writing by the first user.

10. The method of claim 8, further comprising the steps of:
(e) selecting a group within the plurality of third party users by the first user; and
(f) producing the at least one first block of the writing to the selected group of third party users.

11. The method of claim 8 further comprising the steps of:
(e) producing a plurality of second blocks by at least one of first user and the plurality of third party users creating a plurality of branches, wherein the at least one of the first user and the third party users are able to add additional blocks to each branch.

12. The method of claim 8 further comprising the step of:
(e) producing at least one third block, wherein the third block comprises a segment of the writing that is a continuation of the story of the first block or the second block.

13. The method of claim 8, wherein the segment of writing is a chapter of a book or a scene of a drama.

14. The method of claim 8, further comprising the step of:
(e) editing the produced blocks by at least one of the first user and the third party users.
